(19) United States
(12) Patent Application Publication
(10) Pub. No.: US 2023/0210213 A1
(43) Pub. Date: Jul. 6, 2023

(54) ARTICLE OF FOOTWEAR INCLUDING MULTI-LAYERED SOLE STRUCTURE

(71) Applicant: Under Armour, Inc., Baltimore, MD (US)

(72) Inventors: Fred Dojan, Portland, OR (US); Monie Gaba, Portland, OR (US); James Webster, Portland, OR (US)

(21) Appl. No.: 18/148,569

(22) Filed: Dec. 30, 2022

Related U.S. Application Data
(60) Provisional application No. 63/295,262, filed on Dec. 30, 2021.

(51) Int. Cl. A43B 13/12; A43B 13/04; A43B 13/18; B29D 35/14

(52) U.S. Cl. CPC A43B 13/12; A43B 13/04; A43B 13/186; A43B 13/185; B29D 35/142; B29K 2083/00

(57) ABSTRACT

A sole structure for an article of footwear includes an upper layer formed of a first foam material and a lower layer formed of a second foam material and having a hardness that is greater than a hardness of the upper layer. In addition, a plate can be disposed between the upper layer and the lower layer, where the plate has a hardness that is greater than each of the upper and lower layers.

### CROSS-REFERENCE TO RELATED APPLICATION

This application claims priority from U.S. Provisional Patent Application No. 63/295,262, filed Dec. 30, 2021, and entitled “Footwear Including Sole Structure Layers Formed with Supercritical Foam,” the entire disclosure of which is incorporated herein by reference.

### FIELD OF THE INVENTION

The present invention relates to an article of footwear and, in particular, a sole structure for an article of footwear designed for flexibility, resiliency and combined with comfort to a user, particularly a runner.

### BACKGROUND

Articles of footwear typically include an upper and a sole structure attached to the upper. For example, athletic footwear typically includes an upper secured (e.g., via adhesive and/or stitching) to a sole structure, which can include a midsole and an outsole. The midsole typically provides some level of cushioning to a user depending upon a particular use. The outsole is typically provided to engage the surface upon which the user is walking or running, where the outsole is also designed with some level of abrasion resistance to withstand some degree of wear during use. The outsole is also typically designed to be a harder material in relation to the more cushioned midsole.

A variety of different sole structure configurations having varying designs and degrees of cushion, flexibility and rigidity are known, where the different configurations can be designed depending upon the terrain in which the footwear is used as well as a particular user activity (e.g., walking, running/jogging, hiking, etc.). For example, a runner typically desires a shoe that provides comfort to the user's foot while ensuring adequate cushioning and flexibility to prevent foot injuries and/or enhance user performance for a particular running activity. For example, for long distance (e.g., marathon) runners, it is desirable to use a shoe including a sole structure that can provide sufficient cushioning and resiliency to protect the runner's foot during impact with the ground surface (often a pavement or other hard surface). However, the outsole is also necessary to reduce wear and enhance longevity of the shoe during use. Therefore, a trade-off can exist between providing adequate resiliency, comfort and protection to the runner while also providing sufficient hardness and abrasion resistance to the sole structure so as to enhance long term use of the shoe.

Accordingly, it would be desirable to provide an article of footwear (e.g., for running and/or other athletic activities) including a sole structure that maintains adequate cushioning, flexibility and comfort to the user while also enhancing the natural gait cycle (heel-to-toe strike) of the user during foot movements as well as providing adequate ground surface contact protection against wear and tear of the sole structure.

### SUMMARY OF THE INVENTION

In example embodiments, a sole structure for an article of footwear comprises an upper layer comprising a first foam material, and a lower layer comprising a foam material and having a hardness that is greater than a hardness of the upper layer. A plate can also be disposed between the upper layer and the lower layer.

In other example embodiments, an article of footwear comprises a sole structure as described herein.

Methods of forming a sole structure utilizing foam forming methods are also described herein.

The above and still further features and advantages of the present invention will become apparent upon consideration of the following detailed description of specific embodiments thereof.

### BRIEF DESCRIPTION OF THE DRAWINGS

FIG. 1A is a top view in plan of a sole structure for an article of footwear in accordance with an embodiment of the invention (footwear configured for a right foot).

FIG. 1B is a bottom view in plan of the sole structure of FIG. 1A.

FIG. 1C is a front/toe end view in elevation of the sole structure of FIG. 1A.

FIG. 1D is a rear/heel end view in elevation of the sole structure of FIG. 1A.

FIG. 2A is a lateral side view in elevation of the sole structure of FIG. 1A.

FIG. 2B is a medial side view in elevation of the sole structure of FIG. 1A.

FIG. 3 is a lateral side view in cross-section (taken along the lengthwise or heel-to-toe direction) of the sole structure of FIG. 1A.

FIGS. 4A, 4B, 4C, 4D, 4E and 4F are cross-sectional views taken in a direction from the toe end toward the heel end of the sole structure of FIG. 1A, where each view is taken along the corresponding broken lines corresponding with the figure as shown in FIG. 1A.

FIG. 5 is a flowchart depicting method steps for an example supercritical foam forming process that an upper layer of the sole structure in accordance with an embodiment of the invention.

FIGS. 6A and 6B are schematic views showing method steps described in the flowchart of FIG. 5 using a reactor and a mold.

FIG. 7 is a flowchart depicting method steps for another example supercritical foam forming process that forms one or more layers of the sole structure in accordance with an embodiment of the invention.

Like reference numerals have been used to identify like elements throughout this disclosure.

### DETAILED DESCRIPTION

In the following detailed description, reference is made to the accompanying figures which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The terms “comprising,” “including,” “having,” and the like, as used with respect to embodiments of the present disclosure, are synonymous.

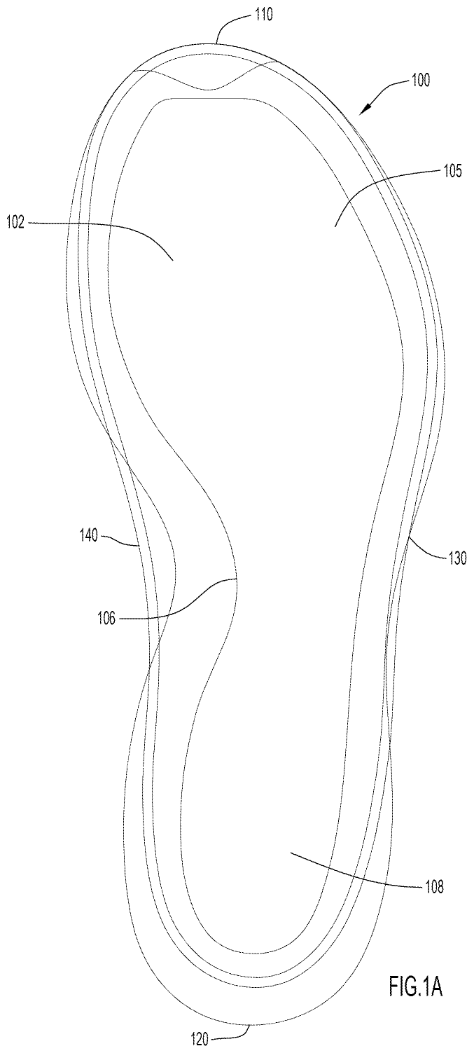

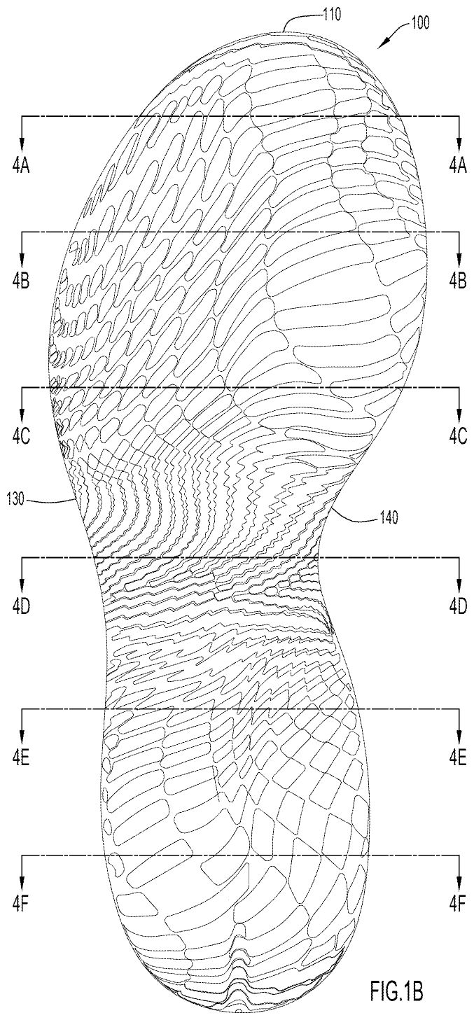

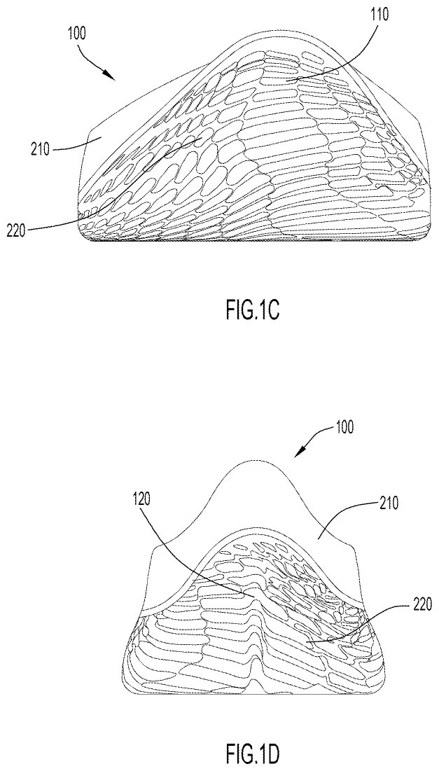

As described herein with reference to the example embodiment of FIGS. 1A-1D, 2A, 2B, 3, and 4A-4F, an article of footwear or shoe includes a sole structure 100 that secures with an upper (not shown), where the upper receives a user's foot when the shoe is worn. The sole structure 100 is formed of a plurality of layers as described herein, where at least one layer is formed utilizing a supercritical foam forming process. When manufactured with the SCF foaming method, a uniform foam structure is produced without material deformation after prolonged use. This not only improves the performance and stability of the foam produced, but also reduces scrap rate and overall energy consumption. In addition, no crosslinking or chemical blowing agents are used in the foaming process, so post-consumer recyclability of the foam is possible.

In example embodiments described herein, the sole structure 1 includes an upper layer comprising a foam material, a lower layer comprising a foam material, and an intermediate or middle layer disposed between the upper and lower layers and that comprises a hard, non-foamed film or plate. At least one of the upper and lower layers (e.g., the upper layer) is a supercritical (SC) foam, i.e., a foam formed using a SC foam forming process.

A foam layer, as described herein, relates to a material layer having closed cells, spaces or voids disposed throughout the material layer, which results in a material layer having a certain level of compressibility and cushioning due to the voids being disposed throughout the material layer. The cell size of polymer foam has been defined as conventional or macrocellular (cell size larger than 100 μm), microcellular (cell size below 100 μm), ultramicrocellular or supermicrocellular (cell size between 0.1-1 μm), and nanocellular (cell size below 0.3 or 0.1 μm). As compared with conventional foam of the same density, microcellular foam is known to possess a higher impact strength.

Polymer foams are primarily manufactured using various foaming processes such as bead, extrusion, injection molding, and batch methods. Standard techniques for producing foam rely on chemical blowing agents and/or crosslinking agents. These processes produce voids or cells within the plastic materials which are relatively large, e.g., on the order of 100 microns or greater. With conventional or microcellular foams, the number of voids per unit volume is relatively low and often there is a generally non-uniform distribution of such cells throughout the foamed material. By way of example, conventional, non-SCF foam possesses a cell density of about 10⁴˜10⁶/cm³ and an average cell size of over 100 microns. Such materials tend to have relatively low mechanical strength; moreover, such traditional, cross-linked foam material is non-biodegradable, requires a high amount of energy to produce, and emits VOCs.

In contrast, supercritical foam is formed by using supercritical fluids, i.e., gases in their supercritical state, which supercritical fluids are supplied to the materials to be foamed. The supercritical fluid is used as the foaming agent in a parent material, preferably, for example, in a polymer plastic material. Specifically, the supercritical fluid saturates the polymer without the need to raise the saturation temperature of the process to the melting point of the polymer. The resulting foamed material can achieve a cell density of several-hundred-trillion voids per cubic centimeter and microcellular, ultramicrocellular, or nanocellular average void or cell size (e.g., foam material prepared by supercritical fluid foaming technology generally has a cell density of 10⁹ to 10¹⁵ cells/cm³ and a cell size of less than 1.0 micron and/or less than 0.1 micron).

The SC foam forming process creates a closed-cell foam that offers lower environmental impact and performance benefits. Unlike foamed materials that rely on chemical foaming agents, SC foam is produced using CO2 and N2 gases. This provides benefits such as no residues from chemical foaming agents in the final products, low/no VOC emission, reduced weight, low thermal conductivity, high strength to weight ratio. Thus, SC foam not only reduces environmental impact, but may produce a foam having up to greater resilience and less weight than conventional (non-supercritical) foams. Stated another way, for foam materials with the same density, supercritical foam can exhibit better mechanical properties due to higher cell density and smaller cell size.

As used herein, the term “supercritical fluid foam forming process” or “SC fluid foam forming process” refers to a foam material that is formed in which a raw or intermediate polymer composition (e.g., molten polymer, polymer beads/pellets, or a blank or solid preform polymer material structure) is subjected to a supercritical (SC) fluid. In an embodiment, a polymer is placed in a mold, where a supercritical fluid is introduced a first temperature and at a first pressure for a time period sufficient for the supercritical fluid to impregnate the polymer. The temperature and pressure are then changed to a second temperature and a second pressure sufficient to produce the polymeric foam having microcellular structure. In and embodiment, the supercritical fluid may be CO₂ and/or NO₂. In an embodiment, the polymer used for supercritical foaming may be ethylene-vinyl acetate copolymer (EVA), thermoplastic polyurethane (TPU), thermoplastic polyester elastomer (TPEE (HYTREL®)), or a block polymer (e.g., SEBS, one or more mixtures of ether amide elastomers (PEBAX®)). The high temperature and/or high pressure causes the raw or intermediate material to form a foam structure that is filled with generally uniform voids, is lightweight and of low density. In an embodiment, the void or cell size of the SC foam is less than 100 microns, e.g., less than 10 microns or less than 1 micron. For example, the cell size can be in a range from about 0.1 micrometer (micron) to about 10 microns, such as from about 0.1 micron to about 5 microns. Cell densities, moreover, may be in a range from about 10⁹ to about 10¹⁵ per cubic centimeter of the material.

Referring to FIGS. 1A and 1B, the sole structure 100 includes a top side 102, which connects with an upper (not shown), and a bottom side 104 that engages with the ground surface when the shoe is worn and used (e.g., for running or other athletic activities). The sole structure further includes a front or toe end 110 that corresponds with the toe end of the user's foot when the shoe is worn, a rear or heel end 120 that corresponds with the heel of the user's foot when the shoe is worn, an outward or lateral side 130 that is oriented along the lateral or little toe side of the user's foot when the shoe is worn, and an inward or medial side 140 that is oriented along the medial or big toe side of the user's foot when the shoe is worn. The heel end 120 of the sole structure 100 has a curved shape that combines with a curved heel end of an upper to define a heel cup that generally conforms with the user's heel and extends between the lateral and medial sides 130, 140 of the sole structure 100, upper and shoe. While the example embodiments depicted in the figures show a sole structure for a shoe configured for a right foot, it is noted that the same or similar features can also be provided for a sole structure for a shoe configured for a left foot (where such features of the left footed shoe are reflection or “mirror image” symmetrical in relation to the right footed shoe).

Each of the shoe and corresponding sole structure 100 further includes a forefoot region 105 that generally aligns with the ball and toes of a user's foot (i.e., when a user is wearing the shoe), a midfoot region 106 that generally aligns with the arch and instep areas of the user's foot, and a hindfoot region 108 that generally aligns with the heel and ankle areas of the user's foot. As described in further detail herein, the upper and lower foam layers of the sole structure 100 can have different thicknesses at the forefoot region 105, midfoot region 106 and/or hindfoot region 108 (e.g., where one or both of the foam layers varies in thickness along the lengthwise or heel-to-toe dimension of the sole structure).

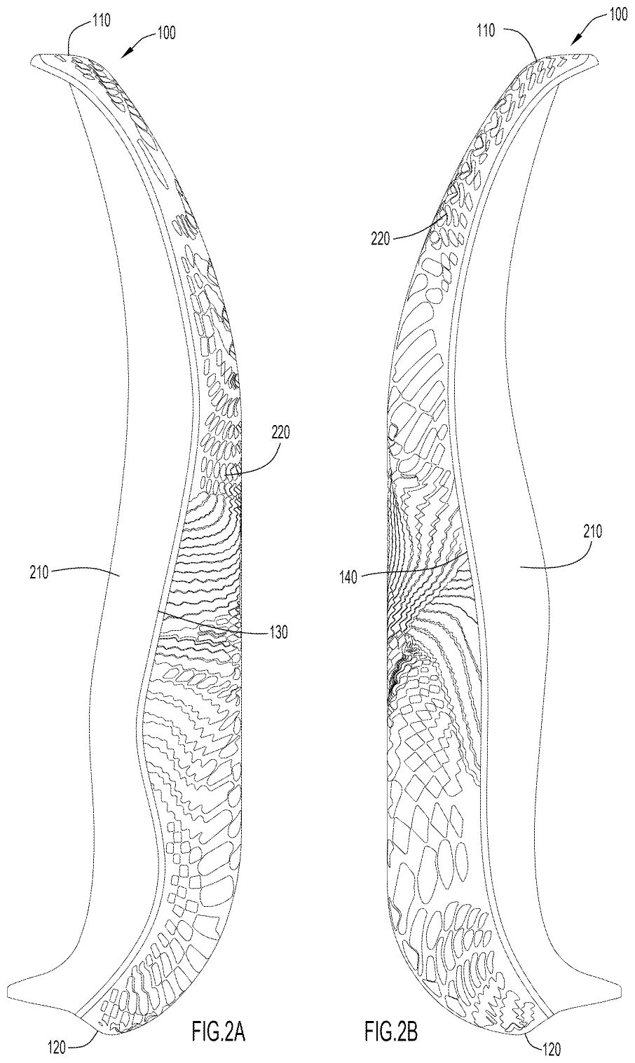

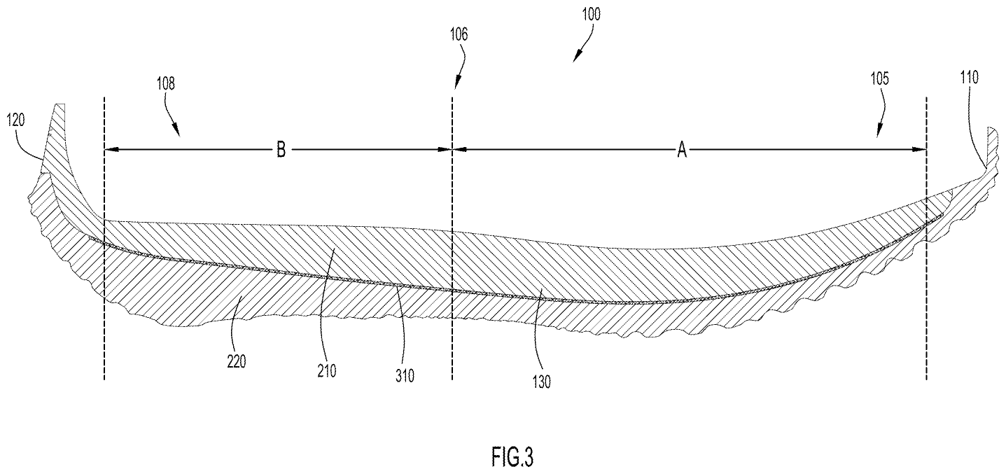

Referring to the cross-sectional view of FIGS. 2A, 2B and 3, the sole structure 100 comprises a first or upper layer 210 and a second or lower layer 220 each of which extends the full length of the shoe upper and/or sole structure from heel end 120 to toe end 110. Disposed between each of the upper and lower layers 210, 220 is an intermediate, nonfoamed layer or thin plate 310.

As can be seen in the cross-sectional view of FIG. 3 and the toe and heel end views of FIGS. 1C and 1D, both the upper layer 210 and the lower layer 220 fully extend to the toe end 110 and to the heel end 120 of the sole structure 100, where the lower layer 220 overlaps and wraps around a portion of the upper layer 210 at the heel end. The lower layer 220 extends slightly beyond and wraps completely around the upper layer 210 at the toe end 110. Accordingly, the lower layer defines the entire exterior surface of the sole structure to function as the outsole that directly engages the running surface. The intermediate layer or plate 310 extends a substantial portion of the lengthwise dimension of the sole structure 100 but does not extend completely to either the toe end 110 or heel end 120. The plate 310 further does not extend to any peripheral edge of the sole structure such that the plate is completely embedded between the upper and lower layers (i.e., the plate is not visible from any exterior surface portion of the sole structure).

Each of the upper layer 210 and the lower layer 220 is formed from a suitable raw polymer material or raw composition that is formed as a foam material. At least one of the upper and lower layers is further formed using a supercritical (SC) fluid foam forming process as described herein. In some embodiments, both layers are formed using a SC fluid foam forming process. In other embodiments, only the upper layer is formed using a SC fluid foam forming process. The polymer materials for each of the upper and lower layers can be formed of the same or different polymer materials and/or can be formed utilizing the same or different foam forming process. Each of the upper and lower foam layers can be formed from one or any combination of polymers (e.g., block copolymers), such as one or more selected from the group consisting of ethylene vinyl acetate (EVA), olefins (e.g., olefin block copolymers that can include, without limitation, C₃-C₂₀ olefins, or C₃-C₁₀ olefins such as propylene, butene, pentene, hexene, heptene and octene), and polyamides.

In an embodiment, the upper layer 210 is a supercritical foam formed from a raw material or raw composition that comprises a polyamide polymer such as a block copolymer formed of polyamide and polyether blocks at a suitable ratio to create a SC foam layer having a specified hardness, a specified density and other desired physical characteristics. The lower layer 220 is a conventional foam formed from a raw material or raw composition comprising an olefin material (e.g., polyethylene). In particular, the raw material forming the lower layer can comprise an olefin polymer material combined with a silicone polymer material so as to form a ground-contacting and abrasion resistant, cushioning foam material that has a greater hardness (e.g., measured on a Shore A Hardness scale) in comparison to the upper layer. The lower layer 220 can further be formed so as to have a suitable wear/abrasion resistance so as to serve effectively as an outsole, thus eliminating the requirement for a more dense and harder rubber outsole for the shoe (and thus also reducing overall weight of the sole structure and shoe).

In particular, the olefin material provided in the raw material used to form the lower layer 220 can comprise an ethylene/α-olefin block copolymer. Typically, at least about 50 mol % of olefin block copolymer may include ethylene-containing hard blocks. In some embodiments, the hard blocks may include at least about 95 wt percent ethylene, and may be 100 wt % ethylene. The ethylene hard blocks may be highly crystalline. The remainder of the olefin block copolymer may be soft blocks of amorphous olefins. Suitable α-olefin fractions include, for example, straight-chain or branched α-olefin having between 3 and about 30 carbon atoms. Cyclo-olefins may also be provided including between 3 and about 30 carbon atoms and di- and poly-olefins having at least 4 carbon atoms. The raw material can also comprise blends of olefin block copolymers. Different compositions may be used to achieve different properties and characteristics, such as hardness, resistance to compression set, or resistance to extremes of hot and cold temperature, in the resultant composition. A non-limiting example of a specific type of olefin block copolymer composition that can be provided in the raw material to form the lower layer 220 is an olefin block copolymer commercially available under the tradename INFUSE (Dow Chemical Company).

The silicone polymer material combined with the olefin material to form the lower layer 220 can comprise silicone rubber that is provided in an amount of about 25 phr (parts per hundred rubber) for the material composition. Minor quantities of other polymers also may be included in this 25 phr of rubbers. Silicone rubber has the general formula [—Si(R1)(R2)-O]m[—Si(R3)(R4)-O]n, where m is between 1 and about 20,000 and n is between 1 and 20,000. Often, differences between silicone rubbers are found in the pendant groups, i.e., R1, R2, R3, and R4. In some embodiments, R1, R2, R3, and R4 each may be individually or separately selected from the group consisting of methyl, phenyl, vinyl, trifluoropropyl, and blends thereof, where at least one of R1, R2, R3, and R4 is vinyl. In some embodiments, R1, R2, R3, and R4 each may be individually selected from the group consisting of an alkyl, and R1, R2, R3, and R4 may be the same alkyl. Other silicone rubber compositions also are available. In some embodiments, the silicone rubber may be a blend of silicone rubbers having different pendant groups.

In an embodiment, one or more suitable crosslinking agents may optionally be provided in one or both raw materials provided to form the upper layer 210 and the lower layer 220 during the foam formation process. The crosslinking agents function to crosslink polymer chains to improve structural integrity and to provide resistance to chemical attack. Cross-linkers are chemical products that chemically form bonds between two hydrocarbons, which may add rigidity to a product. One such cross-linking agent is BIBP, or bis[1-(tert-butylperoxy)-1-methylethyl]benzene. Dicumyl peroxide also may be used as a cross-linking agent. The reaction can release a small amount of heat or absorb that amount of heat depending on the chemical used. For example, for the raw material used to form the second layer comprising an olefin block copolymer and silicone rubber, cross-linking agents can optionally be provided in the raw material in an amount between about 0.5 and 3 phr, e.g., between about 1 and about 2 phr.

In alternative embodiments, each of the upper and lower layers can be formed with polymer compositions that exclude any crosslinking agent.

Pigments (e.g., in the form of fine particulates) can also be provided in one or both compositions used to form the upper foam layer and/or the lower foam layer so as to impart a color to the raw material and resultant foam layer that is formed in the foam forming process. Some non-limiting examples of pigments include titanium dioxide and zinc oxide. In example embodiments, an amount of pigments can be provided in the raw material used to form the lower layer 220 can be from about 1 phr to about 10 phr (e.g., from 1 phr to about 4 phr, or from about 1 phr to about 2 phr).

In certain example embodiments, the raw materials provided that form one or both of the upper and lower foam layers can include minor amounts of other additives, such as anti-oxidants, viscosity modifiers, fillers, release agents, odor absorbents, and other commonly-used additives. Such additives may be present in any combination and may include other minor additives. Further, one or more anti-static agents can also be provided in the raw materials that form one or both of the upper and lower layers. Anti-static agents may help to minimize attraction of dust to the surface of the polymer or of an object made with the polymer. Anti-static agents fall generally into three types: migratory additives, ionic (both anionic and cationic) conductors, and particulates such as carbon black. Migratory additives tend to improve performance as time after manufacture increases. Carbon blacks and particulates provide limited resistivity to dust. However, ionic conductors typically provide essentially constant performance at a level far superior to carbon blacks. In embodiments of the disclosure, ionic conductors may be used to not only reduce static, but surprisingly to improve the abrasion resistance of the layer, making the lower layer suitable for direct ground contact. For example, octane-1-sulfonates can be added to the raw material used to form the lower layer at a level from about 5 phr to about 15 phr (e.g., from about 8 phr to about 12 phr). Other counter cations, such as potassium, can also be used in either or both raw materials used to form the upper and lower foam layers.

The composition of the raw material for each of the upper 210 and lower 220 layers can be selectively varied (including changing components and/or amounts/weight percentages of the components) to correspondingly adjust the hardness, wear resistance, coefficient of traction, and other properties and characteristics of each foam layer. For example, the hardness of the lower layer can be made harder by using an olefin block copolymer comprising more hard blocks. Similarly, varying the types of silicone rubbers in the raw material can change the properties and characteristics of the resultant lower layer. Typically, olefin block copolymers are available in a wide range of properties and characteristics, as are silicone rubbers. This, in combination with the foam forming processes used to form the layers, allows for adjusting the properties of each layer such that the lower foam layer has a greater hardness than the upper layer and each layer has selected characteristics based upon an intended use of the sole structure in a shoe.

The non-foamed, intermediate plate 310 extends the length of the article of footwear (from heel region to forefoot region) and can be formed of a suitably rigid material having greater hardness or durometer (e.g., as measured on a Shore A durometer scale) in relation to each of the upper and lower foam layers but also has suitable flexibility and spring-like resilient characteristics to allow the plate to flex or bend and then return to its original (non-bent) shape (due to its composition and very small thickness, i.e., the plate is much lower in thickness that each of the upper and lower layers) during use of the shoe. In example embodiments, the plate can be formed of a material comprising carbon, such as a carbon material comprising woven carbon fibers combined with a suitable polymer laminate. In other example embodiments, the plate can be formed of other suitably flexible and hard materials including, without limitation, a polyamide material (e.g., PA 12 or nylon 12). The rigid plate is configured to provide enhanced recovery of energy return during walking or running such as areas on or near the ball joint of the foot. The plate may be constructed of materials comprising carbon fiber plate, PEBA (e.g. PEBAX®), TPU, and/or TPEE (e.g., HYTREL®).

Any one or more suitable foam formation processes can be used to form each of the upper and lower foam layers. As previously noted, each foam layer can be formed using the same or similar SC fluid foam formation process. Alternatively, the upper foam layer can be formed from a SC fluid foam forming process while the lower layer is formed utilizing a conventional foam forming process. Stated another way, the first or upper layer may be a supercritical foam and the second or lower layer may be a conventional foam.

An example embodiment of a supercritical fluid (SCF) foam forming process to form at least the first or upper foam layer is now described. Any suitable blowing or foaming agent can be utilized that is capable, at suitably high temperature and pressure, of forming a SCF that produces a cellular structure or voids within the polymer composition during the foaming process when the polymer components undergo a hardening or phase transition during the foaming process. For example, the foaming agent that forms the SCF be converted from a gaseous state (e.g., carbon dioxide, nitrogen and/or steam) to a SCF or a liquid state (e.g., water) to a SCF. A SCF has a critical point at a temperature and pressure at which distinct gas and liquid phases do not exist but at a pressure below that required to convert the fluid to a solid. Some examples of a SCF that can be used in the SC foam forming processes as described herein are water/steam, nitrogen, carbon dioxide, and any combinations or mixtures thereof. Preferably, the SCF used in the SC foam forming processes as described herein is nitrogen, carbon dioxide, or a mixture of nitrogen with carbon dioxide. The SC point of nitrogen is −147° C. and 3.4 MPa, such that compressed nitrogen (or compressed air) above this temperature and pressure will typically yield a SC fluid. The SC point of carbon dioxide is at 31° C. and 7.4 MPa, so that heating and pressurizing carbon dioxide above these thresholds will result in formation of a SCF. Thus, a SCF formed from a combination of CO₂ and N₂ will be at the elevated temperature (i.e., above ambient temperature) and high pressure that is required to achieve the SC point of CO₂.

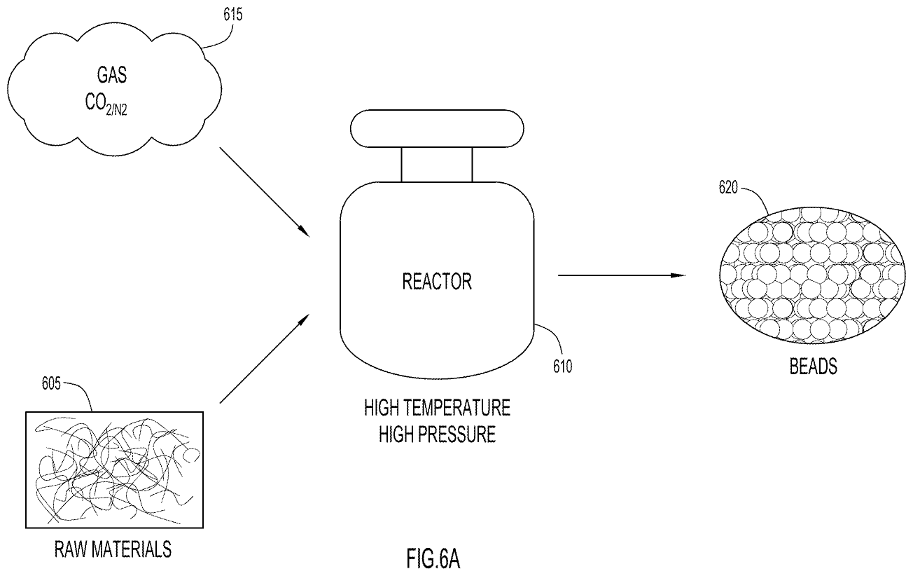

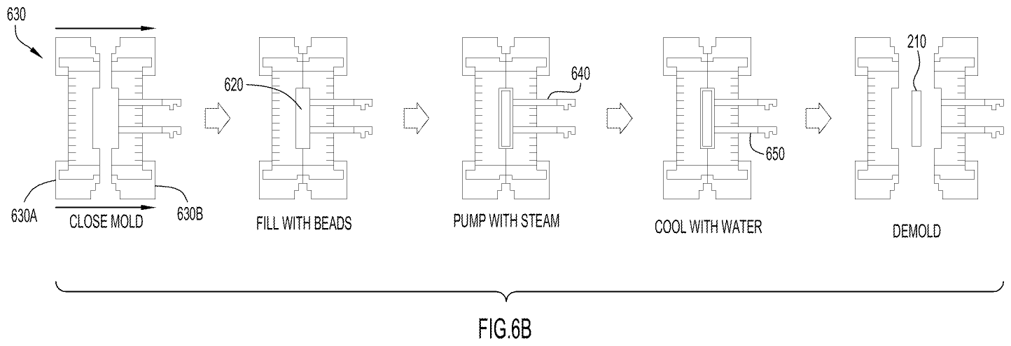

An example embodiment of a first SC foam forming process, used to form the upper foam layer, is described with reference to the flowchart depicted in FIG. 5 and the schematic views of FIGS. 6A and 6B. In this process, beads are first formed from a raw material using supercritical fluid (SCF) (as shown in FIG. 6A) in a first vessel or reactor, and then the beads are fused together and molded in a separate vessel or mold structure to form the upper layer of the sole structure (as shown in FIG. 6B). At 510, a polymer composition or raw material (material 605 as shown in FIG. 6A) is provided into a batch vessel or batch reactor (reactor 610 as shown in FIG. 6A) that is operable at high temperatures and/or high pressures so as to form and maintain a SCF fluid within the reactor for reaction and/or interaction with the raw material. In an embodiment, the raw material is a thermoplastic elastomer such as PEBA, which is formed of rigid polyamide and flexible polyether segments. In further embodiments, the supercritical foam layer may be formed of ethylene vinyl acetate polymer, or of other thermoplastic elastomers such as a polyester thermoplastic elastomer.

The raw material can be in the form of a particulate matter (e.g., granules or particles having various sizes and shapes) or in a fibrous form (e.g., a web of nonwoven or intertangled fibrous material). The raw material can be provided already in a colored state (i.e., dye or pigment already added to color the raw material with a desired color), such that no pigment or dye need be added to the raw material to form the foam having a certain color. The beads of raw material formed by being subjected to the SCF are larger in one or more dimensions than the particulate or fibrous form of the raw material prior to such SCF processing. The beads can further have rounded shapes (e.g., spherical/circular cross-sections and/or prolate spheroid/elliptical cross-sections).

At 520, the reactor is heated and/or pressurized to a suitable temperature and pressure and a gas is injected into the reactor (e.g., gas 615 as shown in FIG. 6A) that forms a SCF. For example, when the foaming agent comprises carbon dioxide, the reactor can be heated or set to a temperature of at least 31° C. and a pressure of at least 7.4 MPa such that the carbon dioxide (and nitrogen, if combined with carbon dioxide) is present as a SCF within the reactor. The gas can be injected into the reactor and then transition to a SCF within the reactor (due to the temperature and pressure within the reactor). Alternatively, the gas can initially be converted to a SCF and then injected into the reactor in its SCF state and further maintained therein as a SCF. In the example embodiment depicted in FIG. 6A, a combination of CO₂ and N₂ are provided to form the SCF used in the bead forming process.

At 530, the SCF interacts with the non-foamed or raw material (e.g., absorbs into the raw material) within the reactor for a suitable residence time period. The article that is foamed may have a regular or irregular shape and may be, for example, a pellet, bead, particle, cylinder, cube, sphere. Pellets, beads, or particles may be generally spherical, cylindrical ellipsoidal, cubic, rectangular, and other generally polyhedral shapes as well as irregular or other shapes, including those having circular, elliptical, square, rectangular or other polygonal cross-sectional outer perimeter shapes or irregular cross-sectional shapes with or without uniform widths or diameters along an axis. Upon decrease of pressure and/or temperature such that the fluid transitions from its SC state to gaseous state, foaming and conversion of the raw material occurs where the raw material is converted from its particulate or fibrous state into rounded or spherical components or beads of a substantially uniform size distribution (e.g., beads 620 as shown in FIG. 6A).

At 540, the beads formed by exposure to the SCF are removed from the reactor and provided in a mold, e.g., a mold 630 as schematically depicted in FIG. 6B. In particular, a mold can comprise two or more structural pieces or mold parts (e.g., parts 630A and 630B as shown in FIG. 6B) with facing sides that are hollowed such that, when pressed together (e.g., in a clamshell or other configuration), the mold parts fuse the beaded material together under heat and pressure to form a single, integral and unitary piece or product. In the example embodiment, steam is provided at 550 (e.g., steam 640 is provided into the mold via inlet and outlet lines) at a suitable temperature (e.g., about 150° C.) and a suitable pressure (e.g., about 3 bar or 0.3 MPa) for a sufficient time period (e.g., for about 2 minutes) to fuse the beads together within the mold. The steam can then be replaced with water (e.g., at ambient temperature) to cool the fused product, prior to displacing the mold parts from each other and removing the resultant unitary product which forms the upper foam layer 210 of the sole structure 100.

The resultant product or upper foam layer 210, as a result of fusing beads together in the mold which were formed via a SC fluid foam forming process, has substantially uniformly sized and similarly shaped air gaps, cells or voids throughout the foam layer, which differs from conventional foam products in which voids or cells defined throughout the conventional foam layer can be of significantly differing shapes and sizes. In contrast, the voids within a supercritical foam is substantially uniform with microcellular dimensions (e.g., cell or void diameters) from about 0.1 micrometer (micron) to about 10 microns, such as from about 0.1 micron to about 5 microns. In particular, partial bead shapes can still be present at exterior surface portions of the upper foam layer. The interior voids or cells formed within and throughout the upper foam layer can further be defined by the curvature or curved shapes of the beads being fused together. The upper foam layer 210 formed by the SC foam forming process also has a lower density than conventional foams, is very lightweight and further has a higher resiliency that provides a high energy return when compressed and decompressed during use in a sole structure for a shoe (e.g., during ground engaging movements of the shoe when the sole structure is pressed and then released by the user's weight against a ground surface).

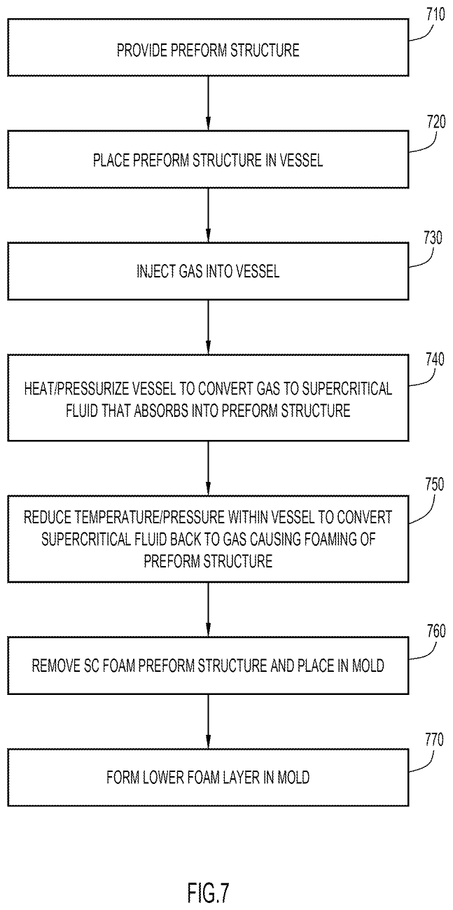

While the lower foam layer can be formed in the same or similar manner as the upper layer (using a different starting, raw material), this layer can also be formed utilizing a different SC fluid foam forming process or a foam forming process that does not utilize a SCF. An example SCF foam forming process utilized to form the lower foam layer is described with reference to the flowchart of FIG. 7. At 710, a one piece, unitary blank or preform structure or member comprising a raw material, such as an olefin block copolymer (e.g., INFUSE) combined with a silicone polymer, is provided. The raw material can already be colored such that no pigment or dye is added to the raw material in the SCF foam forming process. The preform member can be formed in any suitable manner prior to being subjected to the SCF foaming process. In an example embodiment, the raw material can be provided in particulate form (e.g., pellets) that is melted and injected into a first mold and heated and/or pressurized to form a preform member of the raw material. At 720, the preform member is placed within a suitable vessel (e.g., an autoclave) configured to be pressurized and heated to the suitable temperatures of the SCF. At 730, a fluid, such as CO₂ (or a combination of CO₂ with N₂) can be injected into the vessel, and at 740 the vessel is heated and/or pressurized (e.g., heated to a temperature of at least 31° C. and pressurized to a pressure of at least 7.4 MPa) so as to convert the fluid to a SCF and cause the SCF to interact with the SCF within the vessel (e.g., by absorption of SCF into the preform member, causing its expansion and forming voids within the member).

At 750, after a sufficient time period in which the SCF interacts with the preform member (e.g., saturates the preform member), the pressure and/or temperature within the vessel is reduced below the critical point of the SCF, the SCF converts back to a gas and expands to cause voids or cells to form within the preform member and corresponding expansion of the preform member into a foam preform member having a greater volume than in its initial form. The SC foaming process also results in voids or cells formed throughout the foam preform member that are substantially uniform in size and shape and further are smaller than cells or voids that are present in conventional foam materials. The foam preform member further has a density that is lower than conventional foam materials. In an embodiment, the cell density is in a range from about 10⁹ to about 10¹⁵ per cubic centimeter of the material

At 760, the foam preform member is removed from the vessel and placed within a cavity of a final, second mold. At 770, the second mold shapes and forms the foam preform member under elevated temperature and/or elevated pressure to form the resultant product or lower layer 220 of the sole structure 100.

The plate 310 can be formed to have any suitable curvature along its length as well as any suitable flexibility characteristics to facilitate and moderate the amount of flex associated with each of the upper and lower foam layers when the shoe is worn and used. The plate 310 further extends a substantial portion of the length of the sole structure, extending continuously along the forefoot region 105, midfoot region 106 and hindfoot region 108 of the sole structure to facilitate control of the foam layers.

The sole structure can be formed by combining the upper and lower layers together, with the plate disposed therebetween, in any suitable manner. For example, the plate 310 can be placed or adhered to a top side or top surface of the lower layer 220, and the upper layer 210 can then be placed (with a bottom side or bottom surface of the upper layer facing the top surface of the lower layer) over the lower layer 220 and plate 310 and secured to the lower layer and plate in any suitable manner (e.g., via adhesive).

The polymer components for each of the upper foam layer 210 and the lower foam layer 220, as well as the process (SCF foam forming or other foam forming process) used to form the upper and lower foam layers, can be adjusted to achieve the desired amount or fine tuning of cushion, compression, resilience, energy return (i.e., amount of energy retained by layer when a force is exerted on the layer), hardness and abrasion resistance/durability properties for each layer for a particular purpose. In example embodiments described herein and in which the upper foam layer is formed from a raw material comprising a polyamide polymer (e.g., PEBAX) and the lower foam layer is formed from a raw material comprising a mixture of olefin block copolymer and silicone polymer (e.g., an INFUSE material), as well as the SCF foaming processes by which one or both layers is formed, imparts different properties for each foam layer that combine with the hard and flexible plate to enhance performance and comfort of the shoe that incorporates the sole structure (e.g., in running applications).

For example, using methods of forming the upper and lower foam layers as described herein, the upper foam layer can have a lower density and a greater amount of cushion and higher resiliency/higher energy return (going from compression to expansion of the lower layer) during use in comparison to the upper layer. As previously noted, the plate functions to moderate the amount of flex in the upper layer and can enhance the resiliency and energy return of the upper layer and also the sole structure during use. The lower layer has a greater hardness/durometer value than the upper layer and thus is not as soft/resilient as the upper layer. In example embodiments, the upper foam layer can have a Shore A durometer in a range from about 35 to about 45 (e.g., from about 40 to about 43), while the lower foam layer can have a Shore A durometer in a range from about 45 to about 60 (e.g., from about 48 to about 52, or about 50). Thus, both layers are relatively soft and of low density (due to the voids or cells provided throughout the foam layers), but with the lower layer being harder (greater Shore A durometer value) and more dense (greater density) than the upper layer.

The use of silicone polymer combined with olefin block copolymer facilitates a selective adjustment in the hardness and abrasion resistance/durability of the lower layer (e.g., by controlling amount of hard blocks in the olefin block copolymer, controlling amount and/or types of silicone polymer in the raw material, and selectively controlling the foam forming process used to form the lower layer). The lower layer thus has suitable durability and wear/abrasion resistance such that an outsole layer (e.g., rubber outsole) is not required for the sole structure, thereby maximizing weight reduction of the sole structure. In other words, the lower layer effectively functions as an outsole and provides a bottom surface that is the ground engaging surface 145 of the sole structure 100. The bottom or ground engaging surface 145 of the sole structure 100, defined by the bottom surface of the lower layer 220, can have grooves, tracks, indentations, protrusions and/or any other three dimensional surface features (e.g., as depicted in FIG. 1B) that serve as ground engaging or traction elements/treads for the sole structure.

In addition, the sole structure can also be modified, depending upon a particular application, to include any one or more further layers between lower foam layer and plate, between plate and upper layer and/or over the upper layer. The one of more further layers can be formed of any suitable types of materials and have any suitable thicknesses and configurations (e.g., further foam layer, textile layer, etc.). Alternatively, the sole structure can include only the upper and lower layers, with the intermediate plate optionally provided between the upper and lower layers, and with the upper layer configured for coupling directly with an upper of an article of footwear or shoe.

The properties of the overall sole structure can further be adjusted or fine-tuned by modifying the thicknesses of the upper foam layer 210, the lower foam layer 220 and/or the plate 310.

In example embodiments, the plate 310 has a generally constant thickness from about 0.5 mm to about 2 mm (e.g., from about 0.5 mm to about 1.0 mm, or about 0.8 mm). The plate can be constructed of a substantially non-compressible, hard material so as to have a Shore A durometer that is significantly greater than each of the upper foam layer 210 and the lower foam layer 220, where the plate can have, e.g., a Shore A durometer value from about 60 to about 80. The plate also has a sufficient flexibility and/or spring-like characteristics along its length to absorb pressure points caused by flexing or bending of the sole structure as well as enhance resilience of each foam layer, and in particular the upper foam layer. As previously noted, the plate can be formed of a material comprising carbon, a polyamide or any other suitable polymer or other material that provides the plate with the desired hardness and flexibility characteristics.

In certain embodiments, the sole structure can be formed without the plate (i.e., no plate between upper and lower foam layers). In such embodiments, the hardness of each foam layer can be adjusted to eliminate the need for the plate depending upon certain uses for the sole structure.

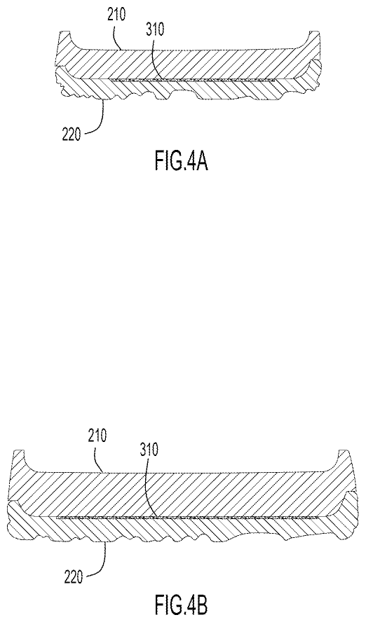

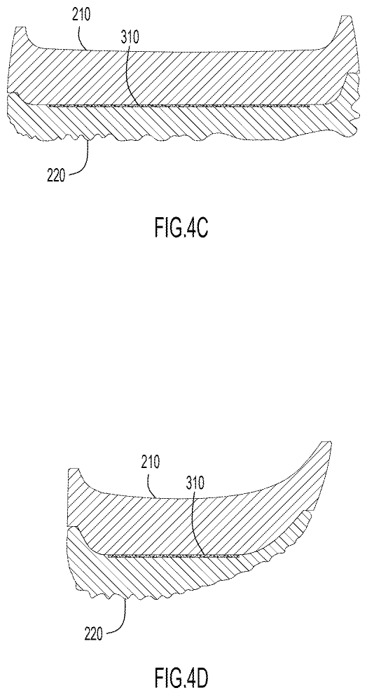

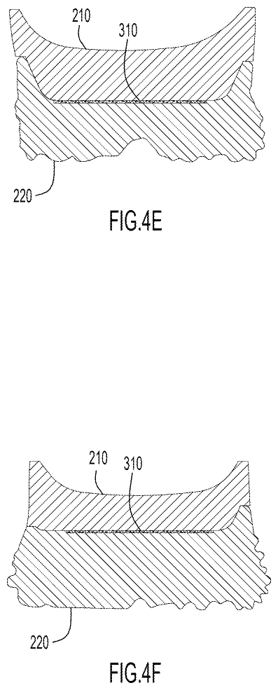

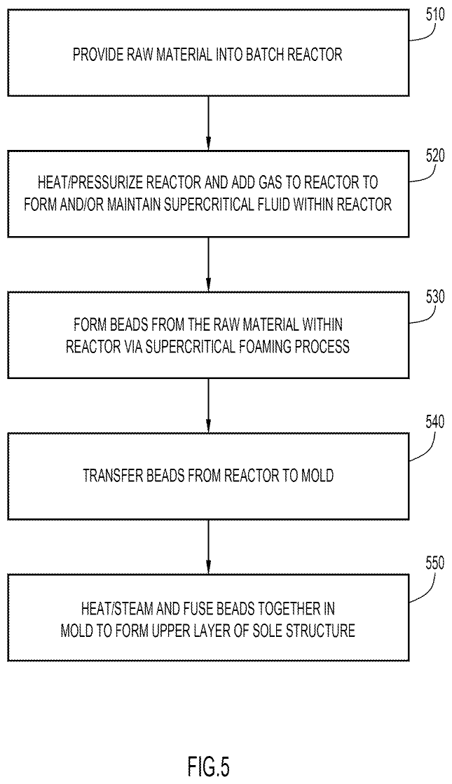

Each of the upper foam layer 210 and the lower foam layer 220 can vary in thickness along a lengthwise (heel-to-toe) dimension of the sole structure. The thickness of each layer can also vary in relation to the other at one or more selected lengthwise dimensions of the sole structure. Such variance of layer thicknesses can be adjusted or tuned depending upon what characteristics may be desired for the shoe (e.g., for long distance or mid distance running applications). In the example embodiment depicted in the figures (see FIG. 3 and also the various cross-sectional views of FIGS. 4A-4F taken at various lengthwise distances along the sole structure as indicated by FIG. 1B), each of the upper layer 210 and the lower layer 220 varies in thickness along its lengthwise dimension. The upper layer 210 has a greater thickness in relation to the lower layer 220 from the midfoot region 106 to the forefoot region 105 (indicated as distance A in FIG. 3), where the lower layer 220 has a very low thickness at portions beneath the plate 310 and near the toe end 110 of the sole structure 100. When traversing the sole structure 100 between midfoot region 106 and hindfoot region 208 (indicated as distance B in FIG. 3), the thickness of each layer varies such that the upper layer 210 has a greater thickness at the midfoot region 206 and extending partially toward the hindfoot region 208, while the lower layer 220 increases in thickness such that it becomes greater in thickness in relation to the upper layer 210 at a portion of the sole structure 100 where both layers extend over the plate 310 and approach the heel end 120.

The SCF foam forming methods and foam layers formed as described herein results in the formation of an enhanced sole structure that is lightweight (due to the sole structure comprising substantially foam), provides excellent resiliency and energy return for the sole structure and shoe during use, has excellent abrasion resistance and durability without the need to add a rubber outsole component to the sole structure as well as enhanced comfort and performance for its various uses (e.g., for running and other athletic activities). The SC foaming process used to form each of the upper and lower layers also results in a very low density, lightweight sole structure product that has greater amount/greater weight percentage (based upon total weight of sole structure) in comparison to conventional sole structures provided for shoes.

The combination of features provided within the shoe sole structure described herein further enhances the natural gait of a user during shoe performance (e.g., during jogging or running) by providing an effective combination of optimal cushioning and flex response along the various regions of the shoe, thus facilitating an effortless heel-to-toe transition during the stance phase of a gait cycle.

While the invention has been described in detail and with reference to specific embodiments thereof, it will be apparent to one skilled in the art that various changes and modifications can be made therein without departing from the spirit and scope thereof.

Thus, it is intended that the present invention covers the modifications and variations of this invention provided they come within the scope of the appended claims and their equivalents. It is to be understood that terms such as “top”, “bottom”, “front”, “rear”, “side”, “height”, “length”, “width”, “upper”, “lower”, “interior”, “exterior”, and the like as may be used herein, merely describe points of reference and do not limit the present invention to any particular orientation or configuration.

What is claimed:

1. An article of footwear comprising:
an upper; and
a sole structure comprising:
a first foam layer extending the length of the upper, the first foam layer possessing a first hardness value;
a second foam layer extending the length of the upper coupled to the first foam layer, the second foam layer possessing a second hardness value, the first hardness value of the first foam layer being less than the second hardness value of the second foam layer; and
an intermediate plate extending the length of the upper and positioned between the first foam layer and the second foam layer, wherein the plate:
possesses a third hardness value that is greater than the hardness values of each of the first hardness value and the second hardness value, and
the plate curves along its length.

2. The article of footwear of claim 1, wherein the first foam layer and the second foam layer are shaped to contour with the curve of the intermediate plate.

3. The article of footwear of claim 1, wherein:
the first foam layer possesses a first thickness;
the second foam layer possesses a second thickness;
the intermediate plate possesses a third thickness; and
the first thickness of the first foam layer and the second thickness of the second foam layer is each greater than the third thickness of the intermediate plate.

4. The article of footwear of claim 3, wherein each of the first foam layer and the second foam layer varies in thickness along a lengthwise dimension of the article of footwear.

5. The article of footwear of claim 4, wherein:
the article of footwear defines a hindfoot region, a midfoot region and a forefoot region; and
the first thickness of the first foam layer is greater than the second thickness of the second foam layer at a location within the midfoot region and the forefoot region of the article of footwear.

6. The article of footwear of claim 1, wherein the first foam layer is lighter than the second foam layer.

7. The article of footwear of claim 1, wherein the first foam layer comprises a first foam composition and the second foam layer comprises a second foam composition, the first foam composition differing from the second foam composition.

8. The article of footwear of claim 7, wherein:
the first foam layer possesses a first cell density;
the second foam layer possesses a second cell density; and
the first cell density is greater than the second cell density.

9. The article of footwear according to claim 8, wherein:
The first foam layer possesses a first average cell size; and
The second foam layer possesses a second average cell size; and
The first average cell size is less than the second average cell size.

10. The article of footwear according to claim 1, wherein the second foam layer forms the outermost layer of the sole structure, defining the outsole.

11. The article of footwear according to claim 1, wherein:
the first foam layer a foam possesses an average cell size of 100 microns or less; and
the second foam layer possesses an average cell size of greater than 100 microns.

12. A sole structure for an article of footwear, the sole structure comprising:
a first foam layer extending the length of the upper, the first foam layer possessing a first hardness value;
a second foam layer extending the length of the upper coupled to the first foam layer, the second foam layer possessing a second hardness value, the first hardness value of the first foam layer being less than the second hardness value of the second foam layer; and
an intermediate plate extending the length of the upper and positioned between the first foam layer and the second foam layer, wherein the plate:
possesses a third hardness value that is greater than the hardness values of each of the first hardness value and the second hardness value, and
the plate curves along its length.

13. A method of forming a sole structure for an article of footwear, the method comprising:
forming a first foam layer from a first raw material via a first process in which the first raw material is subjected to a supercritical fluid to form the first foam layer;
forming a second foam layer from a second raw material, wherein the second foam layer has a hardness that is greater than a hardness of the first foam layer; and
combining the first foam layer with the second foam layer to form the sole structure, wherein the second foam layer is located below the first foam layer within the sole structure, and an exterior surface of the second foam layer forms an exterior ground engaging surface of the sole structure.

14. The method of claim 13, further comprising:
providing a plate between the first foam layer and the second foam layer prior to combining the first foam layer with the second foam layer.

15. The method of claim 13, wherein the forming the first foam layer via the first process comprises:
providing the first raw material in a particulate and/or fibrous form into a batch vessel;
subjecting the first raw material to a supercritical fluid within the batch vessel to form beads of the raw material, wherein the supercritical fluid comprises at least one of supercritical carbon dioxide and supercritical nitrogen and the beads have one or more dimensions larger in comparison to one or more dimensions of the particular and/or fibrous form of the first raw material;
transferring the beads of the raw material from the batch vessel to a mold; and
processing the beads within the mold to fuse the beads together and form the first foam layer.

16. The method of claim 15, wherein the pressure within the batch vessel is at least about 3.4 MPa.

17. The method of claim 13, wherein the forming the second foam layer from the second raw material via the second process comprises:
subjecting the second raw material to a second supercritical fluid to form the second foam layer.

18. The method of claim 13, wherein the forming the second foam layer from the second raw material via the second process comprises:
providing the second raw material as a preform structure within a vessel;
subjecting the preform structure to a supercritical fluid within the vessel, the supercritical fluid comprising supercritical carbon dioxide and/or supercritical nitrogen;
reducing the temperature and/or pressure within the vessel to convert the supercritical fluid within the vessel to a gas to cause expansion of and generate voids within the preform structure so as to form a foam preform structure;
transferring the foam preform structure into a mold; and′
processing the foam preform structure within the mold to form the second foam layer.

19. The method of claim 13, wherein the first raw material comprises a polyamide polymer.

20. The method of claim 13, wherein the second raw material comprises a polyolefin block copolymer and a silicone polymer.
